(19) United States
(12) Patent Application Publication
(10) Pub. No.: US 2002/0000357 A1
(43) Pub. Date: Jan. 3, 2002

(54) GUIDE ROLLERS FOR VEHICLE RAMP

(75) Inventor: J. KIRSTON HENDERSON, FORT WORTH, TX (US)

Correspondence Address: James E. Bradley, Bracewell & Patterson, L.L.P., P. O. Box 61389, Houston, TX, 77208-1389, US

(73) Assignee: J. Kirston Henderson

(21) Appl. No.: 09/254,910

(22) PCT Filed: Jun. 30, 1998
(86) PCT No.: PCT/US98/13520

(51) Int. Cl. B65G 13/00; B60K 1/00; B60K 16/00

(52) U.S. Cl. 193/35 R; 180/65.1

(57) ABSTRACT

A guideway for automated and nonautomated transportation of passengers and cargo has a pair of guiderails enclosed by a shroud. The vehicle wheels are carried within the shroud with ends of the axles extending through the slots. An electrical bus bar is located within the shroud for providing power to the vehicle. Some vehicles have axles which are extensible. The system also has ramps for loading and unloading the automobiles onto the guideways. The guideway ramps allow adjustment of the vehicle wheel track width upon either entering or exiting guideway access ramps by using a system of roller assemblies mounted into the surface of the ramps. The vehicle moves sideways on rollers in the supporting surface so that the vehicle tires are not forced to slide on the supporting surface. One side of the ramp is a V-shaped channel with a central groove for retaining the wheels on one side of the vehicle in line with the ramp. The wheels on the other side of the vehicle ride on a flat roller assembly and are free to extend along their axles.

### DESCRIPTION

This application claims the benefit under 35 U.S.C. § 119(e) of U.S. Provisional Patent Application Serial No. 60/051,625, entitled “Machines for Transport of Passengers and Cargo-Dual-Mode Vehicle Entry and Exit Ramp,” filed Jul. 3, 1997. This application contains technical disclosure in common with, and is a continuation-in-part of U.S. application Ser. No. 08/921,180, currently pending, entitled “Machine for Transport of Passengers and Cargo,” filed Aug. 29, 1997. This application claims the benefit under 35 U.S.C. § 120 of International Application No. PCT/US97/15543, entitled “Machine for Transport of Passengers and Cargo,” filed Sep. 4, 1997.

### TECHNICAL FIELD

This invention relates in general to mass transportation devices and in particular to a vehicle ramp in a mass transportation device.

### BACKGROUND ART

Mass transportation systems have been developed and proposed for a variety of transportation vehicles. In one example, the system uses vehicles which are carried by a cable or track and which stop for passenger or cargo pick-up and drop-off automatically upon demand which is made known to the system by either human input of some type or computer program. Such systems have been used and proposed for use in high traffic density situations. These systems have been designed for relatively low-speed operations and for relatively short distance applications such as within airports and in downtown areas. Vehicles for such systems have been carried on tracks or guideways. Switching of vehicles from track to track or guideway to guideway has generally been accomplished by employing movable track or guideway elements. Vehicles designed for such use may be used only on the tracks or guideways for which they are designed. Use of the tracks or guideways is also restricted to system captive vehicles designed only for track or guideway use. Some limited-use vehicles have been designed for dual road and track use under manual control. Examples of such a vehicle are normal road use trucks equipped with separate wheels to allow them to be driven by railroad maintenance personnel along railroad tracks under manual control. Some normal road-use automobiles have been adapted with either mechanical steering arms designed to cause the car to follow a steering rail mounted along a special roadway, or electronic sensors designed to cause the car to follow magnets or electrified wires embedded in road pavement. Several disadvantages are inherent in these past systems:

1. Some of the systems are capable of providing service only between stations and are incapable of providing door-to-door service to passengers and cargo.

2. Systems designed to allow specially equipped automobiles to operate on automated guideways have not provided on-demand or scheduled station-to-station service for non-automobile passengers.

3. Inability to provide door-to-door service for passengers and cargo greatly restricts the usefulness of station-to-station systems that use track or guideway only vehicles. Provision of such systems makes it necessary to employ other means such as conventional automobiles or trucks either instead of or in addition to the system. Such automobiles and trucks cause pollution of the atmosphere and require expensive and usually parallel networks of roads and highways.

4. In order to enable operation under the fall range of weather conditions, track or guideway based systems must either be located in expensive tunnels or completely covered.

5. Trackways or guideways for past systems have been expensive to build because of needs to provide extensive land grading or massive structural supports for heavy elevated trackways or guideways.

6. Because past automated track or guideway based systems have been designed for relatively short range or low speed operations, they have not been practical for high-speed, long-distance operation. Thus, it is necessary to transfer passengers and cargo between vehicles for transportation over other than relatively short distances.

7. Because of items (1) and (6) above, past rail or guideway based systems using captive vehicles have not provided capability for long-distance, door-to-door service for passengers or cargo.

8. Individual passenger security and privacy are not provided during travel in systems in which relatively large vehicles are used.

9. Automatic point-to-point transportation of cargo is not provided via the same systems providing passenger travel.

10. Systems capable of providing station-to-station passenger service have been unable to accommodate dual mode road use and trackway or guideway use vehicles.

Another system uses special railroad cars equipped with wheel ramps arranged to allow automobiles to be driven onto and off of the railroad car for transport. Such cars and ramps are designed to carry several automobiles over conventional railroads. Ramps are also used at loading and unloading points to allow the cars to be driven onto an off of the rail cars. This system has several disadvantages:

1. The railroad cars are designed to carry a multiplicity of empty automobiles rather than one automobile with passengers.

2. The special railroad cars are designed to operate on conventional railroads rather than on an automated guideway.

3. The ramps for entry and exit of automobiles to the railroad cars are not designed to allow empty railroad cars designed to transport automobiles to pass freely under the entry and exit ramps to reach and leave the automobile loading position.

4. The railroad cars are designed to be pulled by conventional railroad engines as parts of conventional railroad trains rather than operating alone under automated control under their own power and control on an automated guideway system.

5. With some ramps, the vehicle wheels are forced to slide sideways on the ground surface to place them and the vehicle into the desired position.

6. The ramps also apply undesirable force to the sidewalls of the vehicle tires in order to force the wheels and the vehicle to move sideways.

Still another system proposed makes use of dual mode cars for both conventional road and guideway use. This dual mode car is conveyed by a monorail and has a set of separate street wheels for street use. This car has a wide, lengthwise section down the center of the car to accommodate the monorail and can only fit passengers on either side of the car. The monorail drive wheels are complex.

What is needed is a single system with entrance/exit ramps for rapid and efficient transportation of passengers and cargo both on a door-to-door and station-to-station basis for either short range or long-distance.

### DISCLOSURE OF INVENTION

conventional streets and roads with provisions for use of the same vehicles for both guideway and road applications and without transfer of passengers or cargo between vehicles when transferring between roads and guideways. The guideway has a pair of rails enclosed by a shroud. A slot extends through an inner side wall of each of the shrouds. The vehicle wheels are carried within the shroud on wheel contacting surfaces, with ends of the axles extending through the slots. An electrical bus bar is located within the shroud for providing power to the vehicle.

Some of the vehicles of this invention have axles which are extensible from a retracted position to an extended position. In the extended position, the wheels are located within the enclosed rails. In the retracted position, the wheels recess within wheel wells of the vehicle for conventional street use. Other vehicles of this invention are dedicated for use only on the guideway.

Both types of vehicles are automatically controlled during guideway use. Vehicles and guideways are designed to provide protection from weather elements including snow, sleet, ice, and rain accumulation that would interfere with operation of the vehicles on the guideways. The design of the vehicles and guideways are such that switching of vehicles between guideways and on and off of the guideways is accomplished without discontinuities or moving parts in either the guideways or the guideway switching mechanisms. Automated car ferry vehicles are designed to hold and carry a single conventional automobile with passengers on the tracked automated transportation system.

The system also has special ramps for loading and unloading the automobiles onto the ferries from conventional streets and roads. In order to provide a system to accomplish the desired alignment of vehicles entering the guideway entrance ramp and to allow adjustment of the vehicle wheel track width upon either entering or exiting guideway access ramps, a special system of roller assemblies is mounted into the surface of the ramps. The tires of a vehicle entering the ramp are forced into a desired position and alignment and maintained in that alignment and position without application of undesirable forces to the sides of the vehicle tires and without sliding on the surface. The track width of the vehicle wheels is adjusted while the vehicle is rolling forward.

### BRIEF DESCRIPTION OF DRAWINGS

FIG. 1 is a front sectional view of a vehicle and guideway utilized in a mass transportation system that is constructed in accordance with the invention.

FIG. 2 is an enlarged front sectional view of one side of the guideway of FIG. 1.

FIG. 3 is a front sectional view of an automobile ferry, an automobile and the guideway of FIG. 1.

FIG. 4 is an enlarged side sectional view of a portion of the automobile ferry of FIG. 3.

FIG. 5 is a schematic drawing of a loading station for the automobile ferry of FIG. 3.

FIG. 6 is a schematic drawing of an unloading station for the automobile ferry of FIG. 3.

FIG. 7 is an enlarged plan view of an alternate embodiment of a vehicle ramp constructed in accordance with the invention.

FIG. 8 is a sectional end view of the vehicle ramp of FIG. 7.

FIG. 9 is a plan view of the vehicle ramp of FIG. 7.

### BEST MODE FOR CARRYING OUT THE INVENTION

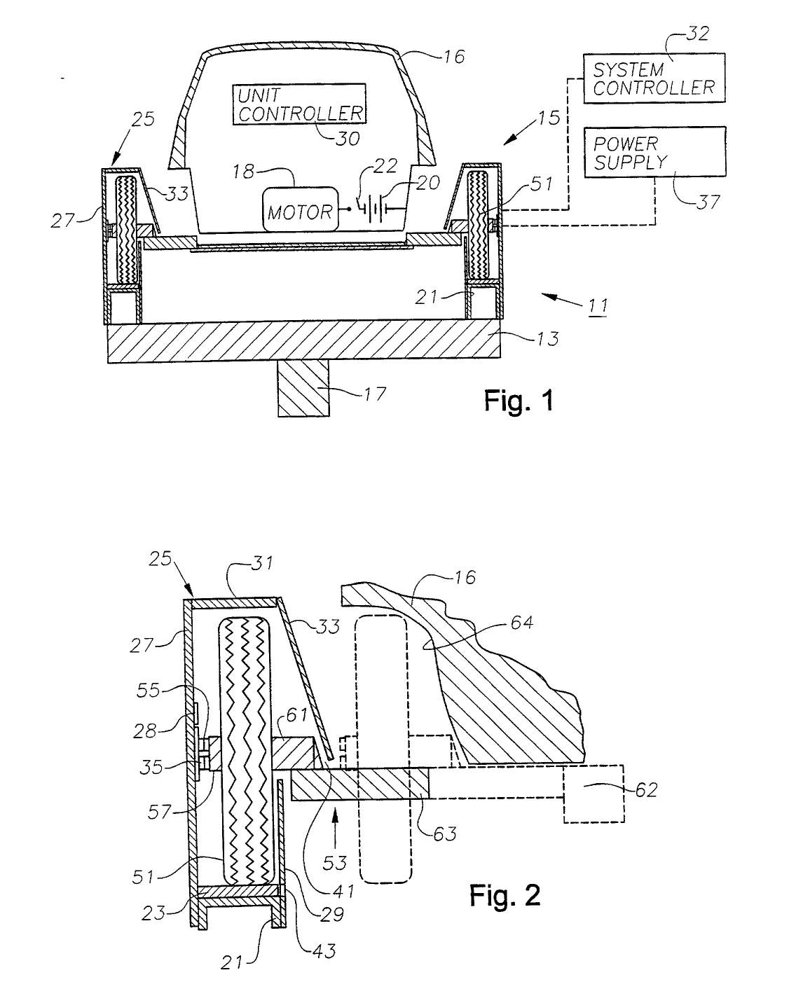

Referring to FIG. 1, a guideway 11 having two enclosed rails 15 for an electric vehicle 16 is shown. Vehicle 16 is electrically powered, having an electrical motor 18 which is powered by a set of batteries 20 while vehicle 16 is driven on conventional roads. A switch 22 between batteries 20 and motor 18 selectively supplies power to motor 18 or disengages batteries 20 from motor 18. In the embodiment shown, enclosed rails 15 are support by a plurality of support structure beams 13 (only one shown) which are elevated above the ground on support columns 17. Each enclosed rail 15 extends along an outer end of support beam 13 and has an internal support channel 21 which is secured to an upper side of support structure beam 13. As shown in FIG. 2, a wheel contact surface or rail 23 is structurally supported from a lower side by each channel 21. Enclosed rails 15 are enclosed by a shroud 25 which extends upward from support structure 13. Each shroud 25 has an external vertical side wall 27, a lower internal vertical side wall 29, a horizontal top 31 and an inclined upper side wall 33 extending downward from top 31. Top 31 joins an upper edge of external vertical side wall 27 and is parallel to rail 23. External vertical side wall 27 supports communication devices 28 mounted along an inner surface for communications between vehicle unit controllers 30 and a system controller 32 (FIG. 1). System controller 32 provides control signals to vehicle unit controller 30 on vehicle 16 by way of communication devices 28. A pair of electrical power bus bars 35 are also mounted along an inner surface of external side wall 27. Power bus bars 35 are supplied with power from a power supply 37 (FIG. 1). The term “bus bar” is used generically to include also other means of transmitting electrical power, such as inductive couplings. Wheel contact rail 23 and power bus bars 35 are removable elements to allow replacement in the event of wear.

Upper side wall 33 is at an angle relative to lower side wall 29 and extends farther inward. A downward facing, longitudinally extending slot 41 is defined between the upper edge of lower inner side wall 29 and upper inner side wall 33. External side wall 27, top 31, and upper and lower inner side walls 33, 29 are arranged to shield the active guideway elements from weather elements such as rain, ice, sleet, and snow. In the event that small amounts of moisture enter the enclosed rails 15, drain holes 43 are located along the inner side of wheel contact rail 23 to allow such moisture to drain from the enclosure.

Vehicle 16 has four wheels 51 (only one shown), all of which will move between an extended position shown by the solid lines and a retracted position shown by the dotted lines in FIG. 2. While in the extended position, vehicle wheels 51 are located within shroud 25 and roll on rails 23. In the extended position, an axle assembly 53 for each pair of wheels 51 extends through slot 41. Each axle assembly 53 has power pickup and steering interface elements 55 located directly ahead or behind of wheel 51 and supported by an insulating member 57. Interface elements 55 contact the track power pick-up and steering rails 35 located at the sides of the enclosed rails 15. Wheels 51 are equipped with rubber tires which roll on rail 23. Rather than a single motor 18, an electric drive motor assembly (not shown) may optionally be located at the hub of each wheel 51 to provide vehicle propulsion. Axle assembly 53 includes parallel and offset axles 61, 63 running from the underside of vehicle 16. An actuator 62 selectively moves axles 61, 63 between the retracted and extended positions. Actuator 62 may be of various types for causing telescoping movement, such as rack and pinion or hydraulic. Rollers (not shown) are mounted at the exits and entrances of guideway 11 to reduce friction between the wheels 51 and support surfaces, allowing lateral outward and inward movement.

Electrical power is supplied by elements 35 to operate vehicle 16 during enclosed rail operation and to charge dual-mode vehicle batteries 20 to provide power to operate such vehicles when not on guideway 11. Offset axle 63 connects the vehicle wheel 51 inside the enclosed rail 15 to the rest of vehicle 16. The offset raises axle 63 over the inner lower vertical member 29. The vehicle steering mechanism is preloaded to cause the vehicle wheels 51 to steer so as to hold power and steering elements 55 in contact with rails 35 at the side of the enclosed rail 15, thereby assuring power transfer and causing the vehicle to steer to follow rails 35. Vehicle control signal interface 28 located on vertical member 27 directly above rails 35, communicates control information between unit controller 30 and system controller 32. Such communications allow speed, position, and switching control of vehicles 16 as well as position tracking of all vehicles using the guideway 11. Vehicle steering and power interfaces are made to follow either the left or right track enclosed rails 15.

The retracted position for each wheel/axle assembly 51, 53 allows vehicle 16 to operate on conventional roads using the same wheels 51, axles 53, brakes (not shown) and motor 18 as are used during guideway 11 operation. While in the retracted position switch 22 is closed, supplying power from batteries 20 to motor 18. When vehicle 16 returns to guideway 11, the wheel and axle assemblies 51, 53 are returned to the extended position to run inside enclosed rails 15. Reconfiguration of dual mode vehicle wheel and axle positions is accomplished by mechanical actuators 62 located inside the dual mode vehicles 16. The retracted wheel and axle assembly position enables the vehicle wheel track width to be narrowed to be within the vehicle body lines to place wheels 51 inside vehicle fender wells 64 for road use. The extended position places wheels 51 outside of the vehicle lines to enable wheels 51 to run inside the enclosed rails 15 of guideway 11. The vehicle outside body line is inward of the enclosed rails 15. FIG. 1 illustrates a dual mode passenger vehicle 16 on guideway 11 with left and right wheel assemblies 51 in their extended positions inside enclosed rails 15 of guideway 11. While on guideway 11, switch 22 will be open as batteries 20 will not be supplying power to motor 18. Motor 18 will receive its power from bus bars 35. Other types of vehicles, such as high passenger count vehicles or cargo vehicles may be similarly configured for use on guideways 11 or as dual mode vehicles for both use on guideways 11 and conventional roads.

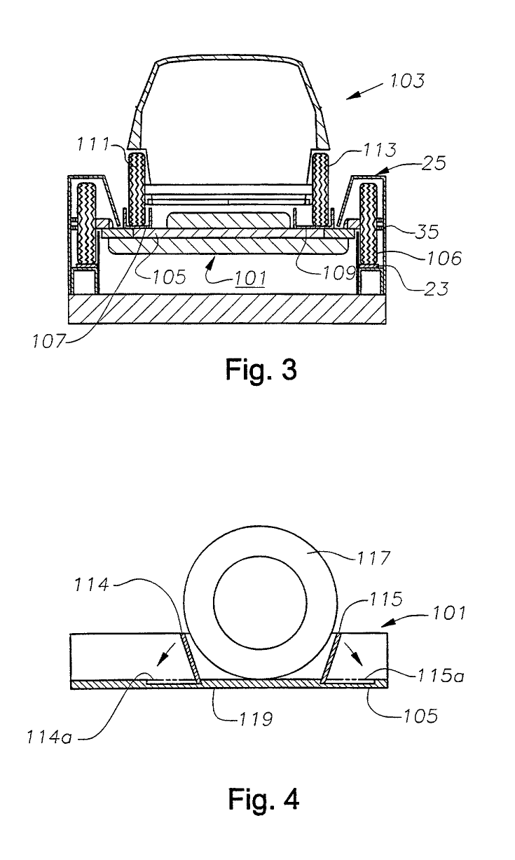

Referring to FIG. 3, automobile ferry 101 is a vehicle for transporting conventional automobiles or cars 103 on guideway 11. Ferry 101 has a bed or platform 105 which is slightly wider and longer than car 103. Platform 105 is elevated above guideway support rail 23 by wheel assemblies 106 which are similar to wheel assemblies 51 in the extended position. Wheel assemblies 106 do not need to retract and extend as ferry 101 is dedicated for use on guideway 11. Ferry 101 has one or more electrical motors (not shown) for powering ferry 101. Power is supplied and control signals transmitted through bus bars 35 and interface 28 (FIG. 1).

Ferry 101 also has channel-shaped car wheel tracks 107, 109 on the top of platform 105 for securing car 103 while ferry 101 is moving. The left hand car wheel track 107 has a width which is designed to position the left automobile wheel 111 in a desired position to assure clearance from the inside of the enclosed rail 15. The car wheel track 109 at the right side has a greater width than track 107 to compensate for a range of different automobile wheel track widths.

As shown in FIG. 4, each wheel track 107, 109 has a pair of wheel stops 114, 115 which are shown in a raised position to constrain the longitudinal movement of car 103 while it is on ferry 101. One of the wheels 113 of car 103 engages wheel track bottom 119 and channel wheel stops 114, 115. The forward wheel stop 115 is shown in the raised position to stop the car in the correct position when driving onto wheel tracks 107, 109. The location of wheel stop 114 is indicated in the lowered position by the solid line 114a. In this position, car wheel 117 is able to roll over lowered wheel stop 114 until it reaches the raised forward wheel stop 115. When car wheel 117 reaches the raised forward wheel stop 115, wheel stop 114 is raised into the position indicated by the dotted line 114 to prevent car wheel 117 from backing up on the wheel track. Upon reaching the destination unloading point, wheel stop 115 is lowered to the position indicated by the dotted line 115a and wheel stop 114 is lowered to the position indicated by the solid line 114a to permit car 103 to drive forward along the track to leave the car ferry.

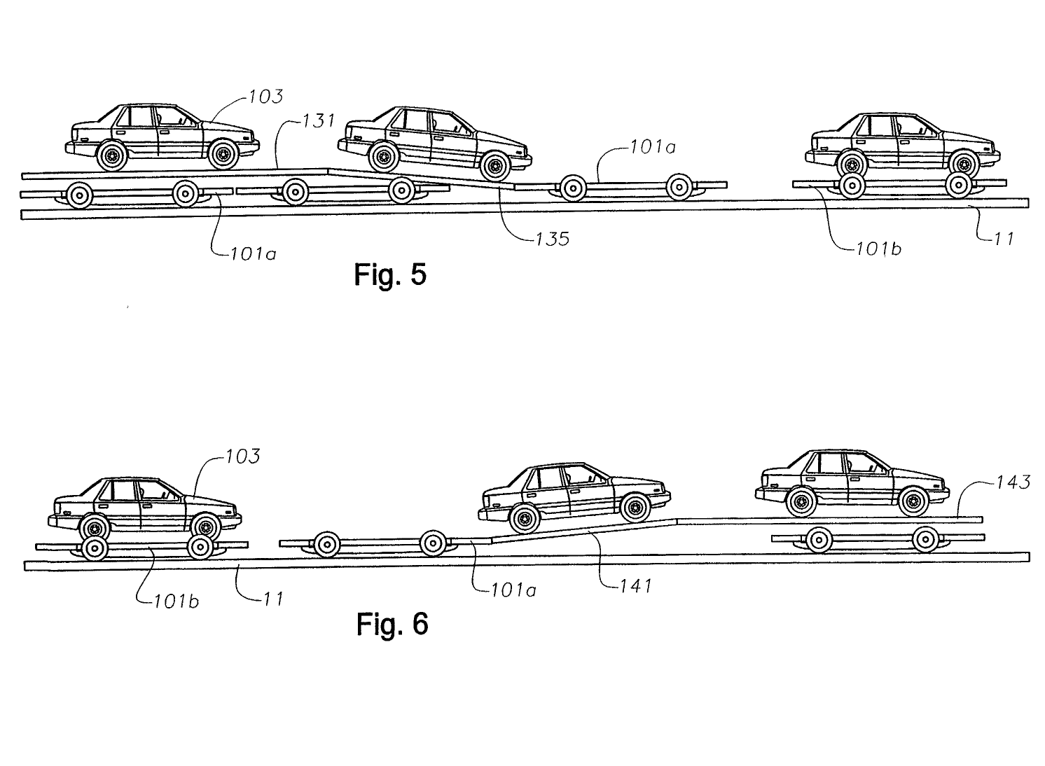

Referring to FIG. 5, conventional cars 103 drive onto an elevated ramp 131 that is located directly above empty car ferries 101a running along a loading station above guideway 11. Empty car ferries 101a stop in a position so that cars 103 can drive down an inclined ramp section 135 onto the car ferry wheel channels. Upon loading, loaded car ferries 101b move away along guideway 11 to the destination selected by the automobile driver under automatic control.

FIG. 6 shows the general arrangement of elements for unloading of automobiles 103 from loaded ferries 101b at the automobile destination. Loaded car ferries 101b approach the unloading point. Car ferries 101b stop at the correct position to allow cars 103 to be driven from the car ferry onto an inclined ramp 141 after the loaded ferry 101b stops. Cars 103 then drive away on an elevated ramp 143 to conventional streets or roads. Unloaded car ferries 101a move away either toward a car loading ramp or toward main line enclosed rails to another station under automatic control.

In its operational form, the ferry system provides a means to load, transport, and unload single conventional automobiles with driver and passengers inside by way of automated car ferries operating on weather-proof enclosed rails. Loaded ferries move non-stop from point of loading to destination as selected by the automobile driver.

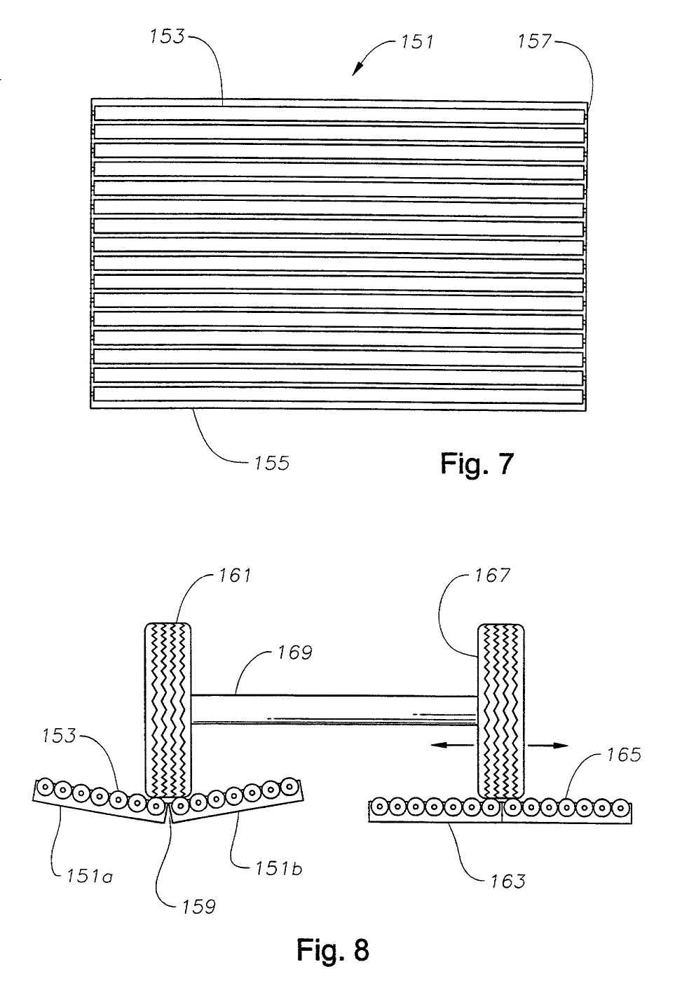

Referring now to FIG. 7, vehicle ramp 151 comprises a set of cylindrical rollers 153, each of which is mounted to a frame 155. A bearing 157 is located between each end of each roller 153 and frame 155. Each roller 153 may rotate independently of the others without contacting them.

As shown in FIG. 8, roller assemblies 151a, 151b with rollers 153 are inclined toward each other in a V-shaped trough at a slight angle of approximately 10° relative to horizontal. A junction 159 is located in the valley between roller assemblies 151a, 151b. Junction 159 may be formed by a hinge (not shown) or may be a permanent trough. Roller assemblies 151a, 151b are configured in such a manner as to cause the vehicle wheel 161 to roll sideways toward junction 159 between the two roller assemblies 151a, 151b. After wheel 161 settles into junction 159, it will roll along in smooth, stable and linear path.

A separate set of roller assemblies 163 is mounted horizontally level in a common plane so that its rollers 165 are able to support and allow the vehicle's other wheel 167 to roll freely from side to side (indicated by arrows) as necessary to position wheel 167 and the supported vehicle at the desired position. Wheels 161 and 167 are connected by an axle 169.

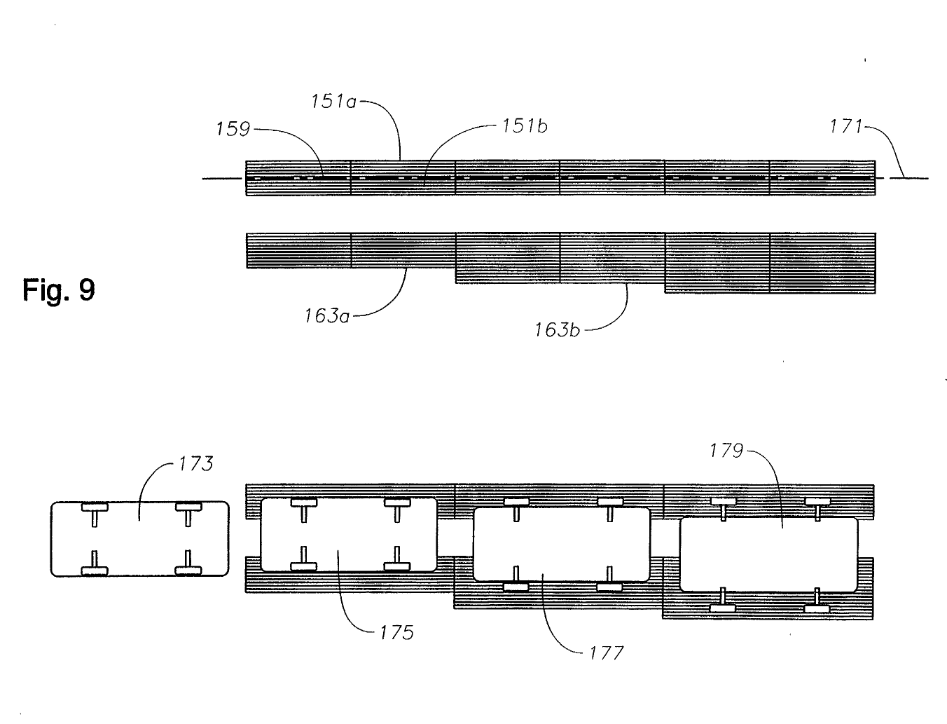

In FIG. 9, the overall arrangement of a guideway system having a pair of parallel tracks is shown. Roller assemblies 151a, 151b are inclined to form junction 159 along the centerline 171 of the track. As stated previously, junction 159 causes the wheels of the vehicles moving onto the system of rollers assemblies 151 to shift and follow the junction 159 as the vehicle moves along the track. Once a wheel is located in junction 159 it will remain there as long as it is on the track. Roller assembly 163a is mounted level to support the wheels on the opposite side of the vehicle and allow the wheels on this side of the vehicle to move freely from side to side as necessary. Roller assembly 163b has greater width than assembly 163a to allow for increasing track of the vehicle as it moves from left to right.

The ramp in the lower portion of FIG. 9 defines a path and alignment for a vehicle illustrated at progressive positions 173, 175, 177 and 179 along the system. As the vehicle enters, it may be expected to be in the incorrect position and alignment as shown at 173. Upon entering the system, the vehicle achieves the desired position and alignment at 175. As the vehicle rolls through the system, the vehicle wheel track width is progressively extended at position 177. By the time the vehicle reaches position 179, the ramp is at its greatest width to accommodate the fully extended wheels. At this point the vehicle is ready to enter the guideway system.

The invention has significant advantages which overcome problems associated with previous systems. The system enables the weight of the vehicle to supply the necessary force to shift the vehicle sideways to achieve the desired alignment and position. The vehicle moves sideways on rollers in the supporting surface so that the vehicle tires are not forced to slide on the supporting surface. No side force is applied to the vehicle wheels to accomplish the desired sideways movement of the vehicle and its wheels. The wheels on one side of the vehicle are placed in and maintained in a desired position without undue side forces being applied to the vehicle tires and wheels. The wheels on the opposite side of the vehicle are allowed to move freely in a sideways movement during vehicle wheel track width adjustments without sliding actions with respect to the supporting surface by maintaining the wheels on a system of rollers in the supporting surface arranged to roll in the direction of the necessary wheel movement.

Although only the preferred embodiments of devices for carrying out the invention have been disclosed above, it not to be construed that the invention is limited to such embodiments. Other modifications may be made by those skilled in the art without departing from the spirit and scope of the invention. For example, the rollers may be used to help align conventional cars with the ferries and loading/unloading ramps. The rollers may also be used in other non-guideway applications where it is necessary to align vehicles with minimal effort.

1. A staging assembly for enabling alignment of a vehicle with a desired position, comprising:
a channel for engagement by a first set of wheels on a first side of a vehicle, the channel extending parallel to a longitudinal axis of the staging assembly; and
a set of rollers located adjacent to the channel for engagement by a second set of wheels on a second side of the vehicle, the rollers enabling lateral movement of the second set of wheels.

2. The staging assembly of claim 1 wherein the channel comprises a first roller section having two portions which are inclined relative to each other to form a trough therebetween, such that the first set of wheels rides in the trough.

3. The staging assembly of claim 2, wherein each of the portions of the first roller section are inclined at approximately 10° relative to horizontal.

4. The staging assembly of claim 1 wherein the set of rollers are supported on bearings which are mounted to a frame.

5. The staging assembly of claim 1 wherein the set of rollers progressively widens from an entry portion to an end portion.

6. The staging assembly of claim 1 wherein the rollers are mounted on bearings and are generally parallel to a longitudinal axis of the ramp.

7. The staging assembly of claim 1 wherein the channel has a substantially constant width and wherein the set of rollers has a greater width than the channel.

8. The staging assembly of claim 1 wherein the set of rollers has a progressively increasing width along the longitudinal axis to allow for an increasing track width of the vehicle as it moves forward.

9. A staging assembly for enabling alignment of a vehicle upon entering the staging assembly, comprising:
a first roller assembly mounted to the staging assembly and having inclined portions which define a junction therebetween so as to allow a set of wheels on one side of a vehicle to move sideways into the junction of the inclined portions while the vehicle is moving forward without applying a lateral force to a set of wheels on an opposite side of the vehicle; and
a second roller assembly mounted to the staging assembly and having a level portion which supports the set of wheels on the other side of the vehicle such that they may move freely from side to side as necessary to manipulate each of the wheels and the vehicle at a desired position while the vehicle is moving forward.

10. The staging assembly of claim 9 wherein each of the first and second roller assemblies comprises a frame with a plurality of rollers which are mounted on bearings to the frame and which are generally parallel to a longitudinal axis of the staging assembly.

11. The staging assembly of claim 9 wherein the first roller assembly has a constant width and wherein the second roller assembly has a greater width than the first roller assembly to allow for an increasing track width of the vehicle as it moves forward.

12. The staging assembly of claim 9 wherein the second roller assembly has a progressively increasing width to allow for an increasing track width of the vehicle as it moves forward.

13. The staging assembly of claim 9 wherein each of portions of the first roller assembly are inclined at approximately 10° relative to horizontal.

14. The staging assembly of claim 9 wherein the second roller assembly has a progressively increasing width along a longitudinal axis to allow for an increasing track width of the vehicle as it moves forward.

15. A method for transporting passengers and cargo, comprising:
(a) providing a vehicle with first and second wheels on opposite sides of the vehicle which are axially movable along axles of the vehicle between retracted and extended positions;
(b) providing a ramp at an entrance to the guideway, the ramp having a channel which extends parallel to a longitudinal axis of the ramp, and a set of rollers located adjacent to the channel;
(c) moving the vehicle onto the ramp and engaging the first wheels on a first side of a vehicle with the channel and the second wheels on a second side of the vehicle with the rollers; and
(d) moving the first and second wheels from the retracted position to the extended position, the rollers allowing the second wheels to move laterally outward from the channel.

16. The method of claim 15 wherein step (d) occurs while the vehicle is moving forward along the ramp.

17. The method of claim 15 wherein step (b) comprises providing the channel with roller sets which incline relative to each other, and wherein step (d) comprises causing the first wheels to move laterally to a junction between the roller sets.
